(19) United States
(12) Patent Application Publication
(10) Pub. No.: US 2026/0015004 A1
(43) Pub. Date: Jan. 15, 2026

(54) SUPPORT INFORMATION PRESENTATION APPARATUS

(71) Applicant: TOYOTA JIDOSHA KABUSHIKI KAISHA, Toyota-shi (JP)

(72) Inventors: Masahiro HIRAKO, Tokyo (JP); Yudai SADAKUNI, Tokyo (JP); Arata TAKADA, Toyota-shi (JP)

(73) Assignee: TOYOTA JIDOSHA KABUSHIKI KAISHA, Toyota-shi (JP)

(21) Appl. No.: 19/223,450

(22) Filed: May 30, 2025

(30) Foreign Application Priority Data
Jul. 12, 2024 (JP) 2024-112640

(51) Int. Cl. B60W 50/14; B60W 40/08; G06V 20/59; G06V 40/16

(52) U.S. Cl. CPC B60W 50/14; B60W 40/08; G06V 20/597; G06V 40/172; B60W 2040/0809; B60W 2050/143; B60W 2050/146; B60W 2420/403; B60W 2540/043; B60W 2556/10

(57) ABSTRACT

A support information presentation apparatus that presents support information to a driver of a vehicle, the support information including a driving support function available in the vehicle and a section in which the driving support function is available. The support information presentation apparatus includes: a use determination unit configured to determine whether there is a driving support function available on a traveling route on which the vehicle is scheduled to travel; a use information acquisition unit configured to acquire a use history by the driver regarding the driving support function determined to be available; and a presentation control unit configured to, when it is determined that there is a driving support function available, present the support information.

### CROSS-REFERENCE TO RELATED APPLICATIONS

This application is based upon and claims the benefit of priority from Japanese Patent Application No. 2024-112640, filed on Jul. 12, 2024, the entire contents of which are incorporated herein by reference.

### TECHNICAL FIELD

The present disclosure relates to a support information presentation apparatus that presents support information concerning a driving support function of a vehicle.

### BACKGROUND

For example, Japanese Unexamined Patent Application Publication No. 2023-93162 discloses an apparatus that notifies a user of a vehicle that a driving support function is executable. This apparatus determines, based on traveling data of the vehicle, whether or not conditions for operating the driving support function are satisfied. When the conditions are satisfied, the apparatus notifies the user of the vehicle.

### SUMMARY

For instance, a driver of a vehicle may check a travel route before driving the vehicle (before departure), such as when the driver sets a destination in a navigation system. In addition, the driver may wish to check in advance, before driving or while the vehicle is stopped, a section along the travel route in which a driving support function can be used. However, in the apparatus described in the above document, a notification is given when the operating conditions of the driving support function are satisfied while the vehicle is traveling, and thus information pertaining to use of the driving support function cannot be obtained in advance before the vehicle travels or while the vehicle is stopped. Furthermore, even when presenting a driving support function available in the vehicle and a section in which the driving support function is available, presenting the same information uniformly to every driver may not always be appropriate.

Therefore, the present disclosure describes a support information presentation apparatus that can more appropriately present a driving support function usable on a travel route and a section in which the driving support function is usable.

A support information presentation apparatus according to one aspect of the present disclosure is [1] “A support information presentation apparatus that presents support information, including a driving support function available in a vehicle and a section in which the driving support function is available, to a driver of the vehicle, comprising: a route acquisition unit configured to acquire a travel route on which the vehicle is scheduled to travel; a use determination unit configured to determine whether the driving support function is available on the travel route; a use information acquisition unit configured to acquire either a use history by the driver of the driving support function determined to be available or a degree of understanding of the driver regarding the driving support function determined to be available; and a presentation control unit configured to, when it is determined by the use determination unit that the driving support function is available, present the support information regarding the driving support function determined to be available, wherein, even if it is determined that the driving support function is available, the presentation control unit does not present the support information when the number of uses of the driving support function, which is derived from the use history, is greater than or equal to a predetermined usage number threshold value or when the degree of understanding of the driving support function is greater than or equal to a predetermined understanding threshold value”.

The support information presentation apparatus according to one aspect of the present disclosure may be [2] “The support information presentation apparatus according to [1], wherein, when presenting the support information, the presentation control unit includes advantages of the available driving support function in the support information”.

The support information presentation apparatus according to one aspect of the present disclosure may be [3] “The support information presentation apparatus according to [1] or [2], wherein, when presenting the support information, the presentation control unit changes a manner of presentation in accordance with at least one of the number of uses or the degree of understanding”.

The support information presentation apparatus according to one aspect of the present disclosure may be [4] “The support information presentation apparatus according to any one of [1] to [3], wherein, when presenting the support information, the presentation control unit further presents, as an illustration, an operation portion among operation portions that a driver operates for driving operation of the vehicle, the operation portion being supported by the available driving support function”.

The support information presentation apparatus according to one aspect of the present disclosure may be [5] “The support information presentation apparatus according to any one of [1] to [4], further comprising a driver identification unit configured to identify the driver who rides in the vehicle based on a face image captured of the driver's face, wherein the use history and the degree of understanding are defined for each driver, and wherein the use information acquisition unit acquires the use history or the degree of understanding corresponding to the driver identified by the driver identification unit”.

According to an aspect of the present disclosure, it is possible to more appropriately present a driving support function available on a travel route and a section in which the driving support function is available.

### BRIEF DESCRIPTION OF THE DRAWINGS

FIG. 1 is a block diagram illustrating an example of a support information presentation apparatus according to an embodiment.

FIG. 2 is an example of a display screen of a display showing a driving support function indication and a usable section indication.

FIG. 3 is an example of a display screen that presents an illustration showing the advantages and the operation parts supported by a driving support function.

FIG. 4 is a flowchart showing a flow of presentation processing of support information performed by the support information presentation apparatus.

### DETAILED DESCRIPTION

Hereinafter, exemplary embodiments will be described with reference to the drawings. In addition, in each drawing, the same or equivalent elements are denoted by the same reference numerals, and repeated descriptions thereof will be omitted.

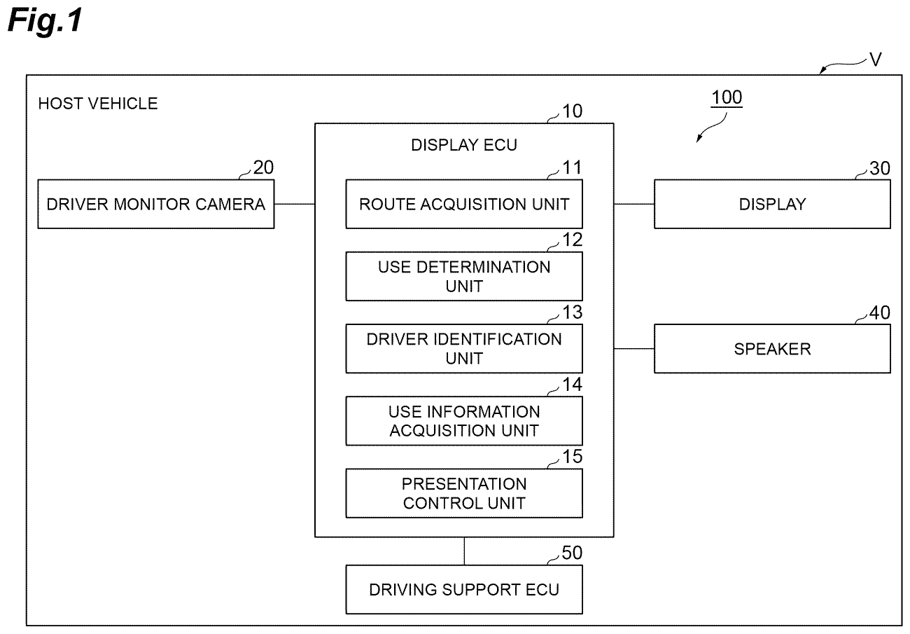

As shown in FIG. 1, a support information presentation apparatus 100 is mounted in a host vehicle V (vehicle). The host vehicle V can travel under manual driving in which a driver operates the vehicle. In addition to manual driving by the driver, the host vehicle V can execute a driving support function that assists the driver in operating the host vehicle V. The support information presentation apparatus 100 presents support information concerning the driving support function of the host vehicle V to a driver (occupant) of the host vehicle V. The support information includes information about the driving support function that can be used in the host vehicle V and a section in which the driving support function can be used. In this way, the driver can recognize, based on the presented support information, which driving support function is available on the travel route of the host vehicle V and in which section the driving support function is available.

The support information presentation apparatus 100 includes a presentation ECU (Electronic Control Unit) 10, which manages the apparatus in an integrated manner. The presentation ECU 10 is an electronic control unit having a Central Processing Unit (CPU) and a storage unit. The storage unit may include, for example, a Read Only Memory (ROM), a Random-Access Memory (RAM), or an Electrically Erasable Programmable Read-Only Memory (EEPROM). In the presentation ECU 10, for example, various functions are realized by executing a program stored in the storage unit on the CPU. The presentation ECU 10 may be configured by a plurality of electronic control units.

A driver monitor camera 20, a display 30, a speaker 40, and a driving support ECU 50 are connected to the presentation ECU 10. These devices connected to the presentation ECU 10 are mounted in the host vehicle V.

The driver monitor camera 20 is an imaging device that captures an image of the face of a driver seated in a driver's seat of the host vehicle V. The driver monitor camera 20 is provided inside a cabin of the host vehicle V. The driver monitor camera 20 is installed so as to be able to capture the face of the driver seated in the driver's seat. The driver monitor camera 20 transmits captured image information (face image) to the presentation ECU 10.

The display 30 is a display device that presents information to the driver of the host vehicle V visually. The display 30 is provided inside the cabin of the host vehicle V. The display 30 may be a center display, a Multi Information Display (MID), or a Head Up Display (HUD). The display 30 displays various information in response to a control signal from the presentation ECU 10.

The speaker 40 is a device that presents information to the driver of the host vehicle V in the form of sound. The speaker 40 outputs sound such as voice in response to the control signal from the presentation ECU 10.

The driving support ECU 50 is an electronic control unit configured by the same type of devices as the presentation ECU 10. The driving support ECU 50 is capable of executing a driving support function that assists the driver in operating the host vehicle V. For example, the driving support ECU 50 executes the driving support function using detection results from external sensors provided to detect an external environment of the host vehicle V.

The driving support ECU 50 can execute the driving support function by controlling the behavior of the host vehicle V. In this case, the driving support ECU 50 controls the behavior of the host vehicle V by outputting a control signal to an actuator provided in the host vehicle V. The actuator may include, for example, at least one of a steering actuator that controls steering of the host vehicle V, a drive actuator that controls the speed of the host vehicle V, and a brake actuator that controls the brake of the host vehicle V. The drive actuator controls the output of a power source (engine or motor, for example) of the host vehicle V.

As examples of the driving support function, the driving support ECU 50 can execute various functions that assist operation by the driver, such as a vehicle speed maintaining function, an inter-vehicle distance control function, and a lane keeping assist function. The vehicle speed maintaining function is, for example, a function that travels the host vehicle V at a preset vehicle speed. This preset vehicle speed may, for example, be set by the driver. The vehicle speed maintaining function may be executed, for instance, on an expressway. The inter-vehicle distance control function is, for example, a function that travels the host vehicle V while keeping an inter-vehicle distance with another vehicle in front. The inter-vehicle distance control function may be executed, for instance, on an expressway. The lane keeping assist function is, for example, a function that controls steering of the host vehicle V so that it does not deviate from a traveling lane. The lane keeping assist function may be executed, for instance, on an expressway.

When the driving support ECU 50 determines that the driving support function becomes available (i.e., conditions for executing the driving support function are satisfied), the driving support ECU 50 may start executing the driving support function based on, for example, an instruction from the driver. Whether or not the driving support function becomes available is determined, for example, based on various conditions set in advance for each driving support function, such as a type of road (general road or expressway) on which the host vehicle V travels.

Next, a functional configuration of the presentation ECU 10 will be described. Functionally, the presentation ECU 10 includes a route acquisition unit 11, a use determination unit 12, a driver identification unit 13, a use information acquisition unit 14, and a presentation control unit 15.

The route acquisition unit 11 acquires a travel route on which the host vehicle V is scheduled to travel. The route acquisition unit 11 can acquire, for example, from a navigation system configured to guide the host vehicle V to a set destination, a travel route on which the host vehicle V is scheduled to travel.

The use determination unit 12 determines whether or not there is an available driving support function on the travel route acquired by the route acquisition unit 11. An available driving support function is a function that can be executed by the driving support ECU 50. For example, the use determination unit 12 may determine the availability of a particular driving support function based on a type of road (e.g., expressway) included in the travel route acquired by the route acquisition unit 11. Specifically, for example, when the travel route acquired by the route acquisition unit 11 includes an expressway, the use determination unit 12 determines that the lane keeping assist function, the vehicle speed maintaining function, and the inter-vehicle distance control function are available in the expressway section.

Note that the use determination unit 12 may not only determine whether a driving support function is available based on the type of road, but also determine whether various driving support functions are available based on the shape of the road and other conditions.

The driver identification unit 13 identifies the driver who rides in the host vehicle V based on a face image of the driver captured by the driver monitor camera 20. The driver identification unit 13 can identify the driver based on a well-known image processing technique that identifies a person from a face image.

The use information acquisition unit 14 acquires either a use history by the driver of a driving support function or a degree of understanding of the driver regarding the driving support function. The driving support function covered by this acquisition is a driving support function determined to be available by the use determination unit 12. Note that the use history and the degree of understanding are defined for each driver. The use information acquisition unit 14 acquires the use history or the degree of understanding corresponding to the driver identified by the driver identification unit 13.

The use history of the driving support function includes the number of uses for which the driving support function was utilized. The use history may also include the date and time on which the driving support function was used. Such a use history is collected for each driver. The use information acquisition unit 14 can, for example, acquire the use history from the driving support ECU 50. Note that the driving support ECU 50, like the driver identification unit 13, may identify the driver based on a face image of the driver captured by the driver monitor camera 20. Based on the result of such identification, the driving support ECU 50 can determine which driver used which driving support function, and collect the use history of the driving support function for each driver.

The degree of understanding of the driving support function denotes the extent to which the driver understands the details of the assistance (i.e., the behavior of the host vehicle V when assistance is executed) and the method for operating the driving support function. The degree of understanding is defined for each driving support function.

For example, a confirmation test may be carried out in advance to check the driver's degree of understanding of the driving support function. The degree of understanding may be determined based on the results of that confirmation test. For instance, the support information presentation apparatus 100 may conduct the confirmation test using the display 30, and acquire the degree of understanding based on the results of the confirmation test. However, this is not limiting; the confirmation test may be performed by a test operator or the like, and the results may be input into the support information presentation apparatus 100 as the degree of understanding. In this way, the use information acquisition unit 14 can acquire the degree of understanding of the driving support function via a variety of methods.

When it is determined by the use determination unit 12 that there is a driving support function available, the presentation control unit 15 presents, as support information, information about the driving support function determined to be available. Namely, if there is at least one driving support function available on the travel route on which the host vehicle V is scheduled to travel, the presentation control unit 15 presents the driver with the available driving support function(s) and the section(s) of the travel route along which the driving support function can be used. When multiple driving support functions are available, the presentation control unit 15 presents support information for each available driving support function. The presentation control unit 15 presents the support information by displaying it on the display 30. Additionally or alternatively, the presentation control unit 15 may present the support information by causing the speaker 40 to output a voice or a sound, alongside using the display 30.

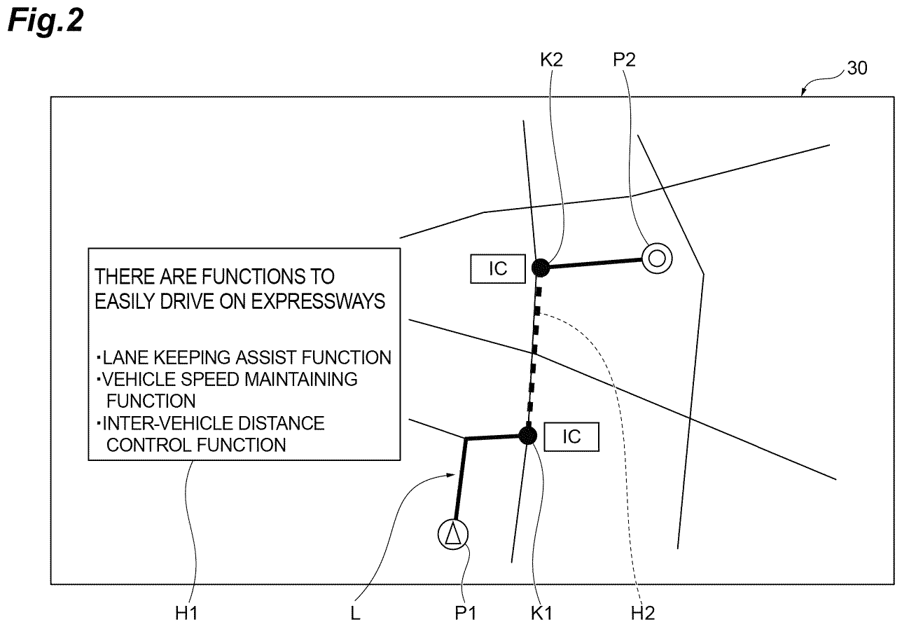

For example, as shown in FIG. 2, the presentation control unit 15 may display the support information in the guidance screen of the navigation system shown on the display 30. In the example of FIG. 2, a travel route L is displayed from the current point P1 to the destination point P2, which the host vehicle V is scheduled to travel.

In the example shown in FIG. 2, the travel route L is indicated by a bold solid line or a bold dashed line. Further, between the point K1 and the point K2, the host vehicle V travels on an expressway, while on other sections, it travels on general roads. The route acquisition unit 11 acquires this travel route L, including information about the types of roads. In the example shown in FIG. 2, the use determination unit 12 has determined that, on the expressway section between point K1 and point K2, the lane keeping assist function, the vehicle speed maintaining function, and the inter-vehicle distance control function are available.

In this case, the presentation control unit 15 causes the display 30 to show a driving support function display H1 for presenting to the driver the driving support functions that are available along the travel route L, as part of the support information. The driving support function display H1 may include names of the available driving support functions. The driving support function display H1 may also include content that evokes the available driving support functions, in addition to the function names. In the example shown in FIG. 2, the statement “There are functions to easily drive on expressways,” along with the specific names “Lane Keeping Assist Function,” “Vehicle Speed Maintaining Function,” and “Inter-Vehicle Distance Control Function,” appears as the driving support function display H1.

In addition, the presentation control unit 15 causes the display 30 to show a usage section display H2 on the travel route L to present, as part of the support information, the section where the driving support function is available. In the example shown in FIG. 2, the usage section display H2, depicted by a bold dashed line between the point K1 and the point K2, indicates that the driving support function is available in that section.

Note that the driving support function display H1 and the usage section display H2 in FIG. 2 are merely examples. The driving support function display H1 may have different wording from the example in FIG. 2, and the display format is not limited to that shown in FIG. 2. Likewise, the usage section display H2 is not limited to using bold dashed lines as illustrated in FIG. 2; the section along the travel route L may be indicated using a different color from the other sections of the travel route L.

When presenting the support information, the presentation control unit 15 can also include advantages of the available driving support function. The “advantages” are benefits to the driver that result from executing the driving support function. Such advantages may include, for example, what driving operations the driver no longer needs to perform once the driving support function is executed, or how the driver's operation is supported.

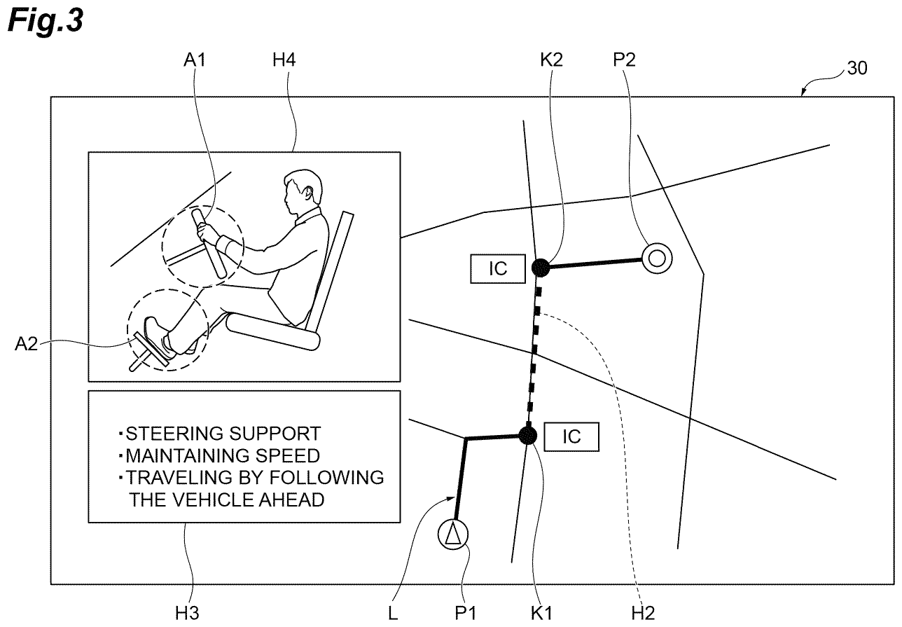

For instance, after the presentation control unit 15 displays the driving support function display Hl shown in FIG. 2, it may then display, on the display 30, an advantage display H3 for presenting the advantages of the available driving support function, as shown in FIG. 3. In the example of FIG. 3, the advantage display H3 includes statements such as “Steering support,” “Maintaining speed,” and “Traveling by following the vehicle ahead.”

Also, when presenting the support information, the presentation control unit 15 may further present, using an illustration, an operation portion that is supported by the available driving support function among the operation portions that the driver operates for driving the host vehicle V. The “operation portion” is a portion that the driver operates for driving the host vehicle V. Specifically, for example, the operation portion may be a steering wheel, an accelerator pedal, or a brake pedal.

For instance, after displaying the driving support function display H1 shown in FIG. 2, the presentation control unit 15 may, as shown in FIG. 3, display an illustration H4 on the display 30 indicating the operation portion supported by the available driving support function. Here, assume that the driving support function provides assistance for operation of the steering wheel and the accelerator pedal. In that case, as shown in FIG. 3, the presentation control unit 15 displays on the display 30 the illustration H4 showing the steering wheel A1 and the accelerator pedal A2, which are supported by the driving support function, enclosed by dashed circles. The illustration indicating the supported operation portion is not limited to using dashed circles as in FIG. 3; any illustration from which the supported operation portion is readily understandable may be employed.

Further, the presentation control unit 15 determines whether to present the support information based on the use history (i.e., number of uses) or the degree of understanding of the available driving support function acquired by the use information acquisition unit 14. Specifically, even if it is determined by the use determination unit 12 that there is a driving support function available, if the number of uses of the driving support function, derived from the use history, is greater than or equal to a predetermined usage number threshold value, the presentation control unit 15 does not present the support information. On the other hand, when the use determination unit 12 determines that there is a driving support function available and the number of uses of that driving support function is less than the predetermined usage number threshold value, the presentation control unit 15 presents the support information.

Alternatively, even if it is determined by the use determination unit 12 that there is a driving support function available, if the degree of understanding of the driving support function is greater than or equal to a predetermined understanding threshold value, the presentation control unit 15 does not present the support information. On the other hand, when the use determination unit 12 determines that there is a driving support function available and the degree of understanding of that driving support function is less than the predetermined understanding threshold value, the presentation control unit 15 presents the support information.

Moreover, when presenting the support information, the presentation control unit 15 may change a manner of presentation according to at least one of the number of uses of the driving support function or the degree of understanding, as acquired by the use information acquisition unit 14. For instance, the presentation control unit 15 may include more-detailed explanations about the support content of the available driving support function in the support information if the number of uses is small, compared with the case when the number of uses is large. Alternatively, the presentation control unit 15 may include more-detailed explanations about the support content of the available driving support function if the degree of understanding of the driving support function is low, compared with the case when the degree of understanding is high. These more-detailed explanations may include, for example, the behavior of the host vehicle V when the driving support function is executed, how to operate the driving support function, and so on.

In presenting more-detailed explanations of the support content of the driving support function, a link to a webpage on which more detailed explanations are provided may be presented. Accordingly, the driver can display the corresponding webpage based on that link and check the detailed support content of the driving support function. For example, the driver may use the support information presentation apparatus 100 to display the linked webpage, or may use a smartphone or a personal computer to display the linked webpage.

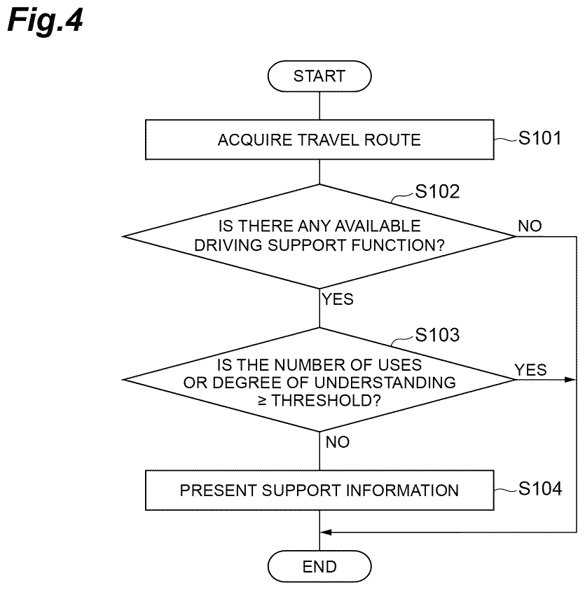

Next, a flow of presentation processing of support information performed by the support information presentation apparatus 100 will be described. The process shown in FIG. 4 is started, for example, based on an instruction from the driver. Alternatively, the process shown in FIG. 4 may be started at a predetermined timing such as when the driver sets a destination in a navigation system and checks the travel route.

As shown in FIG. 4, in S101, the route acquisition unit 11 acquires a travel route on which the host vehicle V is scheduled to travel. In S102, the use determination unit 12 determines whether or not there is a driving support function available on the acquired travel route. If no driving support function is available (S102: NO), the process proceeds to End.

If a driving support function is available (S102: YES), in S103, the presentation control unit 15 determines whether the number of uses of the driving support function acquired by the use information acquisition unit 14 is greater than or equal to a predetermined usage number threshold value, or whether the degree of understanding is greater than or equal to a predetermined understanding threshold value. If the number of uses is greater than or equal to the usage number threshold value, or the degree of understanding is greater than or equal to the understanding threshold value (S103: YES), the process proceeds to End.

If neither the use count nor the degree of understanding is greater than or equal to the threshold (S103: NO), in S104, the presentation control unit 15 presents to the driver of the host vehicle V the support information regarding the available driving support function.

As described above, even if it is determined that there is a driving support function available, if the number of uses of that driving support function is greater than or equal to a predetermined usage number threshold value, or if the degree of understanding of that driving support function is greater than or equal to a predetermined understanding threshold value, the presentation control unit 15 of the support information presentation apparatus 100 does not present the support information. Here, in cases where the number of uses of the driving support function is large or the degree of understanding is high, it can be assumed that the driver already knows or understands the driving support function. Accordingly, if the number of uses or the degree of understanding of the available driving support function is greater than or equal to the threshold, the presentation control unit 15 does not present the support information. As a result, the support information presentation apparatus 100 can suppress any potential annoyance felt by the driver regarding the presentation of the support information, while nevertheless more appropriately presenting the available driving support function and the section in which it is available on the travel route.

The use determination unit 12 determines whether or not a driving support function is available on the scheduled travel route L acquired by the route acquisition unit 11. The presentation control unit 15 then presents support information about the driving support function available on the travel route L that the host vehicle V will travel hereafter. Thus, the driver can recognize in advance-not after the host vehicle V has already reached a point at which the driving support function is available-which driving support function is available on the travel route L and the section where that function is available. In this manner, the support information presentation apparatus 100 can, for example, present support information about an available driving support function when the driver searches a travel route via the navigation system.

When presenting the support information, the presentation control unit 15 presents advantages of the available driving support function (for instance, the advantage display H3 in FIG. 3). Accordingly, the driver of the host vehicle V can understand the benefits that come from executing the presented driving support function.

When presenting the support information, the presentation control unit 15 can additionally change the manner of presentation according to either the number of uses or the degree of understanding. Hence, for example, if the number of uses of the available driving support function is small, the support information presentation apparatus 100 can include a more-detailed explanation about the support content of the driving support function in the presented information, compared with the case when the number of uses is large. Likewise, if the degree of understanding of the available driving support function is low, the support information presentation apparatus 100 can include a more-detailed explanation of the support content of the driving support function in the presented information, compared with the case when the degree of understanding is high.

When presenting the support information, the presentation control unit 15 further presents, using an illustration (for example, the illustration H4 in FIG. 3), an operation portion among those that the driver operates for driving the host vehicle V, where the operation portion is supported by the available driving support function. Thereby, the driver can readily grasp, through an illustrated display, which operation portion is supported by the available driving support function.

The use history and the degree of understanding of the driving support function are defined for each driver. In addition, the use information acquisition unit 14 acquires the use history or the degree of understanding corresponding to the driver identified by the driver identification unit 13. The presentation control unit 15 then presents the support information based on the use history or degree of understanding acquired by the use information acquisition unit 14. Consequently, the presentation control unit 15 can appropriately present the support information for each driver based on the use history or degree of understanding relevant to the driver who is currently in the vehicle. The embodiments of the present disclosure have been described above, but the present disclosure is not limited to these embodiments. For example, at least part of the embodiments and various modified examples described above may be selectively combined in any manner.

What is claimed is:

1. A support information presentation apparatus that presents support information to a driver of a vehicle, the support information including a driving support function available in the vehicle and a section in which the driving support function is available, comprising:
a route acquisition unit configured to acquire a traveling route on which the vehicle is scheduled to travel;
a use determination unit configured to determine whether the driving support function is available on the traveling route;
a use information acquisition unit configured to acquire either a use history by the driver of the driving support function determined to be available or a degree of understanding of the driver regarding the driving support function determined to be available; and
a presentation control unit configured to, when it is determined by the use determination unit that the driving support function is available, present the support information regarding the driving support function determined to be available;
wherein, even if it is determined that the driving support function is available, the presentation control unit does not present the support information when the number of uses of the driving support function, which is derived from the use history, is greater than or equal to a predetermined usage number threshold value or when the degree of understanding of the driving support function is greater than or equal to a predetermined understanding threshold value.

2. The support information presentation apparatus according to claim 1,
wherein, when presenting the support information, the presentation control unit includes advantages of the available driving support function in the support information.

3. The support information presentation apparatus according to claim 1,
wherein, when presenting the support information, the presentation control unit changes a manner of presentation in accordance with at least one of the number of uses or the degree of understanding.

4. The support information presentation apparatus according to claim 1,
wherein, when presenting the support information, the presentation control unit further presents, as an illustration, an operation portion among operation portions that a driver operates for driving operation of the vehicle, the operation portion being supported by the available driving support function.

5. The support information presentation apparatus according to claim 1, further comprising a driver identification unit configured to identify the driver who rides in the vehicle based on a face image captured of the driver's face,
wherein the use history and the degree of understanding are defined for each driver, and
wherein the use information acquisition unit acquires the use history or the degree of understanding corresponding to the driver identified by the driver identification unit.
